(19) United States
(12) Patent Application Publication
(10) Pub. No.: US 2005/0119912 A1
(43) Pub. Date: Jun. 2, 2005

(54) Clearinghouse that enables physicians to submit prescriptions securely over the internet to a pharmacy patients can also access their prescription data over the internet

(76) Inventor: David Samuel Griswold, Ponte Vedra Beach, FL (US)

Correspondence Address: David Samuel Griswold, 240 Clearwater Dr., Ponte Vedra Beach, FL, 32082, US

(21) Appl. No.: 10/722,897

(22) Filed: Nov. 28, 2003

(51) Int. Cl. G06F 17/60

(52) U.S. Cl. 705/2

(57) ABSTRACT

This invention creates an internet-based clearinghouse that enables physicians to electronically create, store, modify, view, and transmit prescriptions using the public internet. Additionally the clearinghouse allows the physician, pharmacy, and patient to communicate electronically on matters regarding prescriptions. All data stored in the prescription database will be accessible to registered users. Access is based on security privilege assigned the user by the clearinghouse. Data stored within the clearinghouse will be accessible anywhere an internet connection exists.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUNG OF THE INVENTION

1. The invention is a clearinghouse that operates over the public internet and supports business to business and customer to business relationships. The specific products handled by the clearinghouse are prescriptions created by a physician for delivery to a pharmacy for any given patient.

2. Currently, physicians create prescriptions for drugs by hand writing the prescription on a paper prescription form, give the paper prescription to the patient, and the patient then delivers the prescription to the pharmacy. The problems with this process are as follows:
a. Patient can lose paper prescription.
b. Pharmacy can lose paper prescription.
c. Patients can forge prescriptions.
d. Pharmacy might not be able to read prescription.
e. Pharmacy must manually enter prescription data into their computer systems.
f. Complete patient prescription history is unavailable.
g. Pharmacy may have outdated patient data on file.
h. Pharmacy must call physician with questions regarding a prescription.
i. Prescription could specify invalid dosage and frequency for a patient.
j. Drug interactions or identification of mutually exclusive drugs difficult.

### BRIEF SUMMARY OF THE INVENTION

The invention is an electronic prescription clearinghouse that operates over the internet. The clearinghouse supports both business to business (B2B) and customer to business (C2B) relationships. The B2B relationship refers to the link created by the clearinghouse between physician and pharmacy. This link allows a physician to electronically submit prescriptions to a pharmacy; and the pharmacy can also communicate with the physician through the clearinghouse.

The C2B relationship refers to the link created by the clearinghouse between physician and his/her patients. Patients can access their current and historical prescription history. Patients can communicate to the physician or pharmacy through the features offered by the clearinghouse.

### BRIEF DESCRIPTION OF THE SEVERAL VIEWS OF THE DRAWING

Not applicable

### DETAILED DESCRIPTION OF THE INVENTION

1. Business Overview

The invention, an electronic prescription clearinghouse, resolves all of the problems itemized in the “Background of the Invention” section of this document. Since the invention is an internet-based software application, the need for a paper prescription is eliminated. The physician creates the prescription using a Web Browser and then electronically transmits the prescription to the pharmacy specified by the patient. Prior to transmitting the prescription, the clearinghouse saves the prescription in its database.

Since prescriptions are transmitted to the pharmacy electronically, they can automatically update the pharmacy computer systems with the transmitted prescription data, thereby avoiding loss of the prescription. Also, since the prescription is typed and not handwritten, all legibility problems are eliminated. If the pharmacy does have questions regarding a prescription, it can email those questions along with the specific prescription back to the physician through the electronic prescription clearinghouse instead of having to call the physician. This elimination of phone calls improves overall efficiency for the pharmacy and the physician, thus reducing operational or administrative costs. The clearinghouse can also eliminate drug dosage and frequency problems by allowing the physician to enter/select drug name, patient age and weight.

The clearinghouse software, otherwise known as the system, will automatically calculate the correct dosage and frequency. The system will also have the ability to check patient prescription history. This would help prevent situations where one physician is prescribing a drug that should not be used with a drug already prescribed by a different physician for that patient. And patients registered with the clearinghouse can go anywhere in the world, and as long as internet access is available, that patient can access and provide their history to a physician or any medical facility.

2. Technical Details

The electronic prescription clearinghouse has been designed using a number of industry standard architectures, frameworks, and open source solutions. Some of those standards and solutions are:
a. Model-View-Controller architecture
b. Component Model architecture
c. Java (J2EE) programming language
d. Java Servlets
e. Java Server Pages
f. Java Mail and Java Activation Framework
g. Apache Struts presentation framework
h. Apache Web Server
i. Apache Tomcat Servlet Container
j. JBoss, EJB Container

The clearinghouse is designed to run on any IBM-, Intel-, SPARC- or RISC-based processor. Additionally, the clearinghouse can also run on any Java compliant web application server and interact with any relational database supporting the Java JDBC interface. It is also possible for the clearinghouse to communicate with the pharmacy using reliable queues or Java Messaging Service. The clearinghouse can also transmit prescriptions in a pharmacy-defined XML format, delimited format, or an industry standard format. User will be able to access the clearinghouse from any Web browser, or hand-held device having access to the internet.

The clearinghouse is designed to run on the public internet using a secure protocol such as HTTPS. The HTTPS protocol ensures the privacy of prescription related data by encrypting that data prior to transmission over the internet. Since the clearinghouse is built on the internet (an open network), barriers to access are eliminated and anybody connected to the internet has access to the clearinghouse.

To ensure that only authorized individuals are able to access the data stored in the clearinghouse, those individuals who require access to the clearinghouse must first register with it. If the clearinghouse approves the registration, it creates a user-Id and password and sends that information to the requesting individual. The individual then accesses the clearinghouse based on the security role assigned to it by the clearinghouse.

1. What I claim as my invention is the creation of a publicly accessible internet-based electronic clearinghouse that processes prescriptions for drugs. Since the clearinghouse runs on the internet, users do not have to install any software or hardware. The only requirement is that they have an internet connection and a Web browser. The clearinghouse will store physician, pharmacy, and patient data according to the rules of HIPM. The clearinghouse supports three types of customers—physicians, pharmacies, and patients. Patients are defined as any person that visits a physician and requires a prescription drug.
Prior to using the clearinghouse, the physician must register with the clearinghouse. Once registered, the physician may create prescriptions using any web browser and then send those prescriptions over the internet to any pharmacy registered with the clearinghouse. The clearinghouse will save every prescription in its database. This allows a physician to search this prescription database for historical purposes or to modify and reissue prescriptions created by that physician.
Prior to using the clearinghouse, the pharmacy must register with the clearinghouse. Once registered, the pharmacy can receive prescriptions from the clearinghouse. The clearinghouse will deliver prescriptions in an industry standard or pharmacy defined format. The pharmacy will receive prescriptions electronically over the internet from the clearinghouse. This will allow the pharmacy to automatically update its computer systems and route the prescription to the specific retail pharmacy. The clearinghouse will also allow the pharmacy to e-mail questions regarding a specific prescription back to the physician that issued the prescription.
Prior to accessing the dearinghouse, the patient must register with the dearinghouse. Once registered, the patent can access the clearinghouse and view their specific prescription history. If a specific prescription has open refills the patient can request the clearinghouse send that prescription to the pharmacy requesting the prescription be refilled. The clearinghouse will notify the physician that the patient has requested a refill if necessary.
